(19) United States
(12) Patent Application Publication
(10) Pub. No.: US 2024/0047928 A1
(43) Pub. Date: Feb. 8, 2024

(54) CRIMPING DRUM FOR A PRESSING TOOL AND PRESSING TOOL

(71) Applicant: Weidmüller Interface GmbH & Co. KG, Detmold (DE)

(72) Inventors: Thilo BRÖKER, Detmold (DE); Detlev HETLAND, Detmold (DE); Günther HANNING, Detmold (DE); Christian HEGGEMANN, Detmold (DE); Siegfried STORM, Schlangen (DE)

(21) Appl. No.: 18/257,214

(22) PCT Filed: Dec. 14, 2021
(86) PCT No.: PCT/EP2021/085758

§ 371 Date: Jun. 13, 2023

(30) Foreign Application Priority Data
Dec. 17, 2020 (DE) 10 2020 133 952.6

(51) Int. Cl. H01R 43/042

(52) U.S. Cl. CPC H01R 43/042

(57) ABSTRACT

A crimping drum for a pressing tool for processing strips of interconnected wire ferrules comprising a housing having a movement axis and a die part arranged thereon, the die part having a nest to accommodate a wire ferrule of the strip, the die part being resiliently accommodated perpendicular to the movement axis in a receptacle of the housing. A pressing tool has two handles which are movable relative to one another, a crimping station with a crimping drum and a crimping stamp, and a depot for storing a strip of interconnected wire ferrules.

This application is a § 371 National stage entry of international patent application No. PCT/EP2021/085758 filed Dec. 14, 2021 which claims priority of patent application No. DE 10 2020 133 952.6 filled Dec. 17, 2020. The entire content of these applications is incorporated herein by reference.

### BACKGROUND OF THE INVENTION

The present invention relates to a crimping drum for a pressing tool and a pressing tool.

A generic crimping drum is known from DE 43 22 856 C1, by way of example. Such crimping drums serve to accommodate wire ferrules that, in the pressing tool, which is manually operable here, for crimping a conductor cable, are fed to the crimping drum. After the feeding, the crimping drum is moved from a receiving position into a crimping position and here an individual wire ferrule is separated from a strip of interconnected wire ferrules.

In the case of this and also other crimping drums known from the prior art, it is necessary to suitably provide receiving nests of different cross-sections for wire ferrules of different cross-sections in the drum. For this purpose, the crimping drum is suitably set in advance in the tool for the inserted wire ferrules by rotating the crimping drum such that the appropriate nest is available when the wire ferrule is fed in.

The problem of the present invention is to further develop a crimping drum, and a pressing tool provided with a crimping drum, such that such a setting to specific cross-sections of wire ferrules can be avoided.

### SUMMARY OF THE INVENTION

This problem is solved by a crimping drum.

The crimping drum according to the invention for a pressing tool for processing strips of interconnected wire ferrules has a housing with a movement axis and a die part arranged thereon with a nest for accommodating a wire ferrule of the strip.

The die part is resiliently mounted in a die receptacle of the housing.

With such a resiliently mounted die part, it is possible to set different conducting cross-sections without altering the crimping drum to respective specific wire ferrule cross-sections.

According to an embodiment of the invention, the die part is mounted resiliently perpendicularly to the movement axis.

According to an alternative embodiment, the die part is resiliently mounted parallel to the movement axis.

According to another embodiment, at least one spring element is arranged between a floor of the die receptacle of the housing and a rear side die part facing away from the nest.

According to yet another embodiment, the spring element is a compression spring, in particular a disk spring. It is also conceivable for the spring element to be a leaf spring, elastomer spring or helical spring.

In particular, the disk spring is distinguished by a high energy density on the short spring path, which makes it possible to form the die part to be structurally small.

In another embodiment, the spring element is arranged on a spring receptacle.

In yet another embodiment, the spring element is a bundle of disk springs.

According to a further embodiment, the spring receptacle comprises a press-on surface with a guiding pin protruding from this, onto which the spring element is placed.

This makes it possible, in a simple manner, to align the spring force counter to the direction of movement of a crimping stamp which functionally interacts with the die part.

According to a further embodiment, on a side facing away from the die receptacle, the housing includes a bore which opens into the die receptacle and in which a tensioning element for tensioning the die part is arranged.

With such a tensioning element, in particular a tensioning screw which can be screwed into a threaded bore, the spring element is pretensioned.

According to a further embodiment, the die part can be pushed axially relative to the movement axis into the die receptacle of the housing. A stop limits the displacement path and is molded on the housing, and a counter-stop which interacts with this and which is molded on the die part is formed as a guiding stop for deflection movement of the die part perpendicular to the movement axis.

The movement axis is preferably a rotation axis, with a translation axis also being conceivable.

It is another object of the present disclosure to provide a pressing tool having a crimping station with a crimping drum and a crimping stamp, and a depot for storing a strip of interconnected wire ferrules. The crimping drum is configured as described above.

The pressing tool is preferably configured as a manually operable pressing tool, with two handles for operating the pressing tool.

### BRIEF DESCRIPTION OF THE DRAWINGS

Preferred embodiments will be explained in greater detail below using the enclosed drawings. In the drawings:

FIG. 1 is an isometric side view of a manually operable pressing tool according to the invention;

FIG. 2 a perspective view of an embodiment of a crimping drum according to the invention;

FIG. 3 is an exploded perspective view of the crimping drum depicted in FIG. 2; and

FIGS. 4-6 are perspective views of the crimping drum of FIG. 3 in the order of assembly of the crimping drum.

### DETAILED DESCRIPTION

In the following description of the figures, terms such as top, bottom, left, right, front, rear, etc. relate exclusively to the exemplary depiction and position, selected in the respective figures, of the crimping drum, the pressing tool, the wire ferrule, die part, housing, nest, spring element and the like. These terms should not be understood to be restrictive, i.e. these references may change through different working positions or the symmetrically identical design or the like.

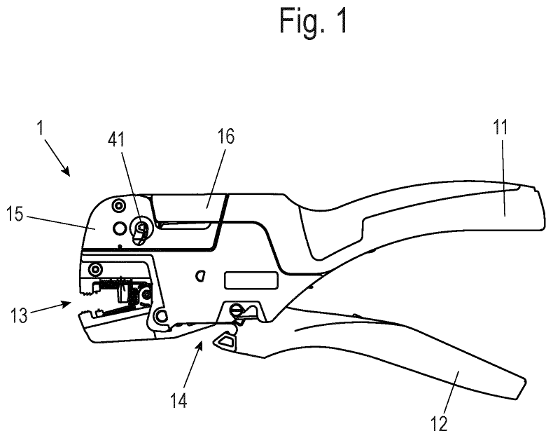

In FIG. 1, a design variant of a pressing tool according to the invention is labelled overall with the reference number 1.

The pressing tool 1, which here is a manually operable crimping tool, has a first handle 11 and a second handle 12 with which the pressing tool 1 can be operated.

Instead of operating the pressing tool via the handle, it is also conceivable to design the pressing tool as an automatic or semi-automatic pressing tool with a motor drive.

The pressing tool 1 has, alongside a crimping unit 15, a cutting unit 14 with which the conductor cable can be cut through.

Furthermore, the pressing tool 1 has a tool mouth 13, in which a sheathing of a segment of the conductor cable being dictated by an operator of the pressing tool 1 can be removed from the conductor strand.

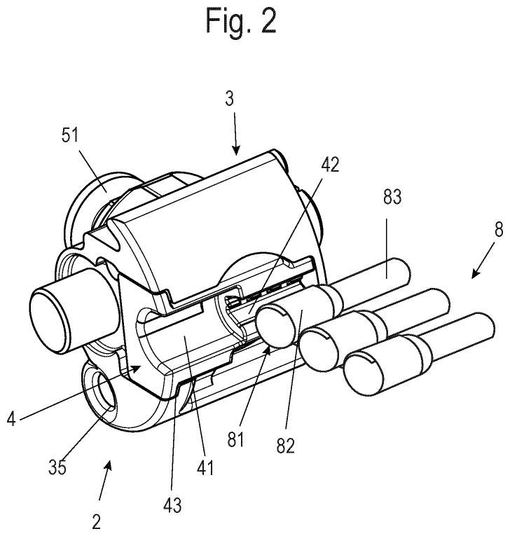

The crimping unit 15 serves to crimp the piece of stripped piece of conductor cable with a wire ferrule 81, as depicted in FIG. 2.

FIG. 2 shows a design variant of a crimping drum 2 according to the invention. The crimping drum 2 is arranged in the crimping unit 15 of the pressing tool 1.

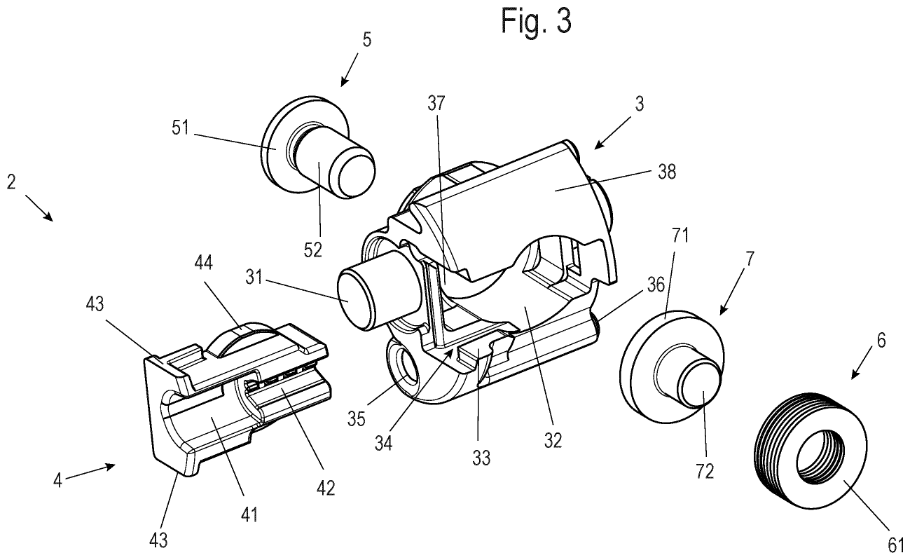

As is shown in FIGS. 2 and 3, the crimping drum 2 comprises a housing 3 which has a movement axis 31, specifically a rotation axis, for rotatory mounting of the crimping drum 2 in the crimping unit 15 of the pressing tool 1.

The crimping drum 2 furthermore has a die part 4 arranged at the housing 3. The die part 4 has a nest 42 for receiving a wire ferrule 81 of a strip 8 of interconnected wire ferrules 81.

The individual wire ferrules 81 are preferably interconnected by a film hinge to form a strip of a plurality of wire ferrules 81.

Each of the wire ferrules 81 preferably has a cladding 82, which surrounds the isolation of a conductor cable, and a metal sheath 83 that encases the strands of the conductor cable.

The die part 4, as depicted in FIG. 2, comprises a nest 42 for accommodating the metal sheath 83 and a cladding receptacle 41 for accommodating the cladding 82 of the wire ferrule 81.

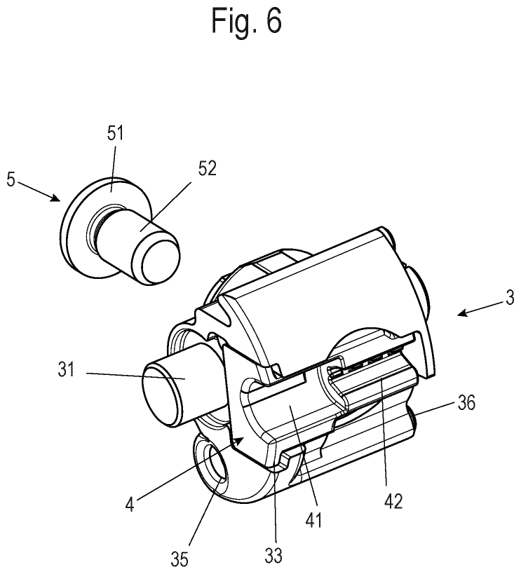

As depicted in particular in FIGS. 3 to 6, the die part 4 is resiliently mounted in a die receptacle 32 of the housing 3 such that the die part is perpendicular to the movement axis 31, and more particularly, radial relative to the movement axis 31, which is a rotation axis.

It is also conceivable to resiliently mount the die part 4 parallel to the movement axis 31.

Resiliently mounting the die part 4 in the die receptacle 32 of the housing 3 has the advantage of inserting and processing wire ferrules 81 of different cross-sections into the die part 4.

To resiliently mount the die part 4 in the die receptacle 32, at least one spring element 6 is arranged between a floor 37 of the die receptacle 32 and a die part 4 rear side facing away from the nest 42.

An example of a spring element 6 is depicted in FIGS. 3-5. The spring element 6 shown here is a bundle of disk springs 61.

It would also be conceivable to employ only one such disk spring 61.

It would also be conceivable to employ other spring elements, such as, for example, leaf springs, elastomer springs or helical springs as compression springs.

The spring element 6 formed here as a bundle of disk springs 61 is placed on a spring receptacle 7, consisting of a press-on surface with a guiding pin 72 protruding therefrom.

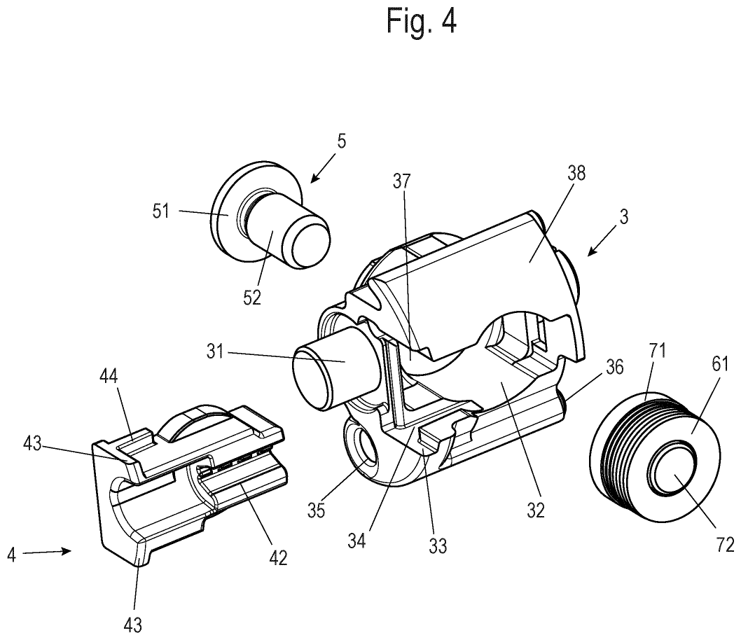

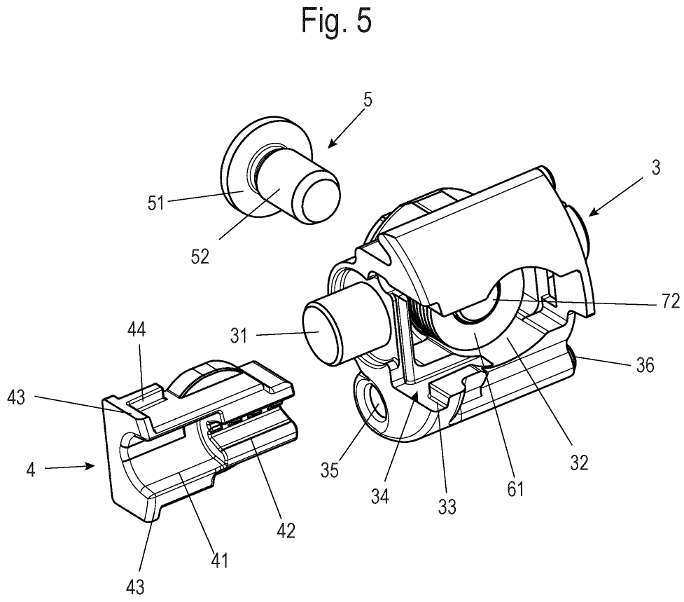

As shown in FIGS. 4 and 5, when assembling the crimping drum 2, the spring element 6 is first placed onto the spring receptacle 7. Thereafter, the spring receptacle 7 is inserted, together with the spring element 6, into the die receptacle 32 of the housing 3.

Thereafter, the die part 4 is pushed in the direction of the rotation axis 31 into the housing 3 through a lateral opening.

To align the die part 4 in the housing 3, stop ridges 43 are molded on the die part 4 outside of the U-shaped or V-shaped nest 42 or the U-shaped cladding receptacle 41 of the die part 4. These stop ridges can be pressed onto corresponding stop faces 33 in the housing 3 which extend in the direction of the spring action of the spring element 6.

A ridge 44 which is oriented parallel to the movement axis 31 and the end face, the latter of which is formed to fit the inner surface of the die receptacle 32 of the housing 3, serves to guide the movement of the die part 4 in the event of a deflection, which may occur when a wire ferrule 81 is inserted. This may happen in particular during a crimping process in which a crimping stamp (not depicted here) is pressed in axially relative to the guiding pin 72 of the spring receptacle 7. In the embodiment shown, a middle region of the end face of the ridge 44 is flat, corresponding to a flat-shaped strip of the inner surface of the die receptacle 32.

A tensioning screw 5, which serves in the axial extension of the guiding pin 72 of the spring receptacle 7 and is screwed into a threaded bore from a rear side of the housing 3 facing away from the spring element 6, to provide pretension to the spring element 6.

The tensioning screw 5 comprises a head 51 by which the tensioning screw 5 can be operated, and a screw neck 52 which protrudes perpendicularly from this and which can be screwed into the threaded bore in the housing 3.

An end side of the screw neck 52 pushes against the press-on surface 71, which faces away from the guiding pin 72, of the spring receptacle 7 which is displaceably mounted axial to the guiding pin 72 in the die receptacle 32 of the housing 3.

As shown further in FIGS. 2 to 6, the housing 3 has, on a surface which is parallel to the end side of the movement axis 31, a recess 35 which interacts with a pin 91 (shown in FIG. 7) of a housing part of the crimping unit 15 such that the pin 91, with the recess 35, serves as a support for a home position of the crimping drum 2.

This pin 91 is formed such that an incompletely executed axial displacement of the crimping drum 2 in the direction of the movement axis 31 after operation of one handle 12, during which the crimping drum 2 is moved sufficiently around its movement axis 31, is either moved back into the starting position or it slips into the crimping position. An intermediate position is thus effectively prevented.

1-14. (canceled)

15. A crimping drum for a pressing tool for processing strips of interconnected wire ferrules, comprising a housing having a movement axis and a die part arranged thereon, the die part having a nest to accommodate a wire ferrule of a strip, wherein the die part is resiliently mounted in a die receptacle of the housing.

16. The crimping drum according to claim 15, wherein the die part is resiliently mounted perpendicular to the movement axis.

17. The crimping drum according to claim 15, wherein the die part is resiliently mounted parallel to the movement axis.

18. The crimping drum according to claim 15, wherein at least one spring element is arranged between a floor of the die receptacle and a die part rear side facing away from the nest.

19. The crimping drum according to claim 18, wherein the spring element is a compression spring including one of a disk spring, leaf spring, elastomer spring and helical spring.

20. The crimping drum according to claim 18, wherein the spring element is arranged on a spring receptacle.

21. The crimping drum according to claim 20, wherein the spring element includes a bundle of disk springs.

22. The crimping drum according to claim 20, wherein the spring receptacle comprises a press-on surface having a guiding pin protruding therefrom onto which the spring element is placed.

23. The crimping drum according to claim 20, wherein the housing comprises a bore arranged on a side facing away from and opening into the die receptacle and in which a tensioning element for tensioning the die part is arranged, the tensioning element extending to the die receptacle.

24. The crimping drum according to claim 23, wherein the bore is a threaded bore in which a tensioning screw for tensioning the die part is arranged, the tensioning screw extending to the die receptacle.

25. The crimping drum according to claim 15, wherein the die part is configured to be pushed into the die receptacle of the housing axially to the movement axis, wherein a stop is molded on the housing for limiting displacement of the die part and a counter-stop is molded on the die part to interact with the stop and to provide a guiding stop for deflection movement of the die part perpendicular to the movement axis.

26. The crimping drum according to claim 15, wherein the movement axis is one of a rotation axis and a translation axis.

27. A pressing tool, comprising
two handles which are movable relative to one another,
a crimping station with a crimping drum and a crimping stamp,
a depot for storing a strip of interconnected wire ferrules,
wherein
the crimping drum is configured according to claim 1.

28. The pressing tool according to claim 27, wherein the two handles are movable relative to one another for operating the pressing tool.
